(19) United States
(12) Patent Application Publication
(10) Pub. No.: US 2005/0141011 A1
(43) Pub. Date: Jun. 30, 2005

(54) Apparatus and method for recording data on and reproducing data from storage medium

(75) Inventors: Sung-hyu Han, Seoul (KR); Yun-sang Kim, Suwon-si (KR); Yang-lim Choi, Seongnam-si (KR); Yong-kuk You, Seoul (KR); Hee-chul Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/994,439

(22) Filed: Nov. 23, 2004

(30) Foreign Application Priority Data
Dec. 24, 2003 (KR) 2003-96192

(51) Int. Cl. G06F 15/00

(52) U.S. Cl. 358/1.14; 358/1.16

(57) ABSTRACT

A method and apparatus for recording data on and/or reproducing data from a storage medium are provided. The recording apparatus includes an authenticating unit which authenticates a host, which transmits a write command to the apparatus, to verify whether the host is authentic; at least one job module which generates output information by processing the user data, which is included in the write command, based on disc information stored in the storage medium and device information stored in the apparatus, in response to the write command; a module selecting unit which selects the job module based on module selection information and sends the write command to the selected job module, when the host is determined to be authentic, the module selection information being contained in the write command and specifying the job module; and a recording unit which records the output information on the storage medium.

This application is based on and claims priority from Korean Patent Application No. 2003-96192 filed on Dec. 24, 2003 in the Korean Intellectual Property Office, the disclosures of which is incorporated herein in its entirety by reference.

### BACKGROUND OF THE INVENTION

1. Field of the Invention

The present invention relates to an apparatus for recording data on or reproducing data from a storage medium, and more particularly, to a storage medium recording/reproducing method and apparatus capable of enabling application software to perform applicative operations based on disc information and device information while providing security.

2. Description of the Related Art

In general, optical discs, which are developed as a large capacity of recording media, are classified into a compact disc (CD) storing music data, a CD-read only memory (CD-ROM) storing computer data, and digital versatile disc (DVD) storing video data.

A type of contents such as video data and/or audio data stored in a storage medium, such as an optical disc, needs to be copyrighted. A copyright on such contents can be securing using encrypting techniques that use control data that includes encrypted content data and key information for decrypting the encrypted content data. For instance, the key information is further recorded on an optical read-only disc storing encrypted content data. When reproducing the encrypted content data from the optical read-only disc using a reproducing apparatus, the reproducing apparatus first reproduces the key information and then decrypts the encrypted content data based on the reproduced key information.

FIG. 1 illustrates an optical disc system including a conventional content protection system. The optical disc system of FIG. 1 includes a storage medium 10 and a recording/reproducing apparatus 20. Data is recorded on or reproduced from the storage medium 10 by application software 100.

The recording/reproducing apparatus 20 is a content protection system that includes a media key generating unit 110, a key generating unit 40, an encrypting unit 50, and a decrypting unit 60. The recording/reproducing apparatus 20 further includes a device identifier 115 that identifies the recording/reproducing apparatus 20, and a device key set 116 that prevents data from being illegally revoked by an authorized recording/reproducing apparatus.

The media key generating unit 110 generates a media key 118 using a media key block 111 read from the storage medium 10, and the device identifier 115 and the device key set 116 installed in the recording/reproducing apparatus. The key generating unit 40 generates an encrypting key 41 or a decrypting key 42 using the generated media key 118, a disc identifier 112 read from the storage medium 10, and other information 113 and 117 related to the storage medium 10 and the recording/reproducing apparatus 20. When using a symmetric key structure as an encrypting/decrypting algorithm, the encrypting key 41 is equivalent to the decrypting key 42. The encrypting unit 50 encrypts user data 119 using the encrypting key 41 and stores the encrypted user data 119 in the storage medium 10. The decrypting unit 60 decrypts user data 114 stored in the storage medium 10 and reads the decrypted user data 114.

The key generating information, which is used to generate the encrypting key 41 and the decrypting key 42, includes the device identifier 115, the disc identifier 112, the device key set 116, and the media key 118. Although the key generating information is very important for content protection, the conventional content protection system of FIG. 1 does not allow the application software 100 directly to access the key generating information so as to protect it from being hacked by unauthorized users.

Accordingly, there is a strong need to develop new application software that allows direct access to the key generating information, for example, so as to encrypt a user password, record the user password on a storage medium, and decrypt information encrypted and stored in a storage medium based on the key generating information. However, the conventional content protection system does not allow such new application software to access to the key generating information.

### SUMMARY OF THE INVENTION

The present invention provides a recording/reproducing apparatus and method that allow application software to access key generating information stored in a storage medium or the recording/reproducing apparatus, while protecting the key generating information.

According to an exemplary embodiment of the present invention, there is provided an apparatus for recording predetermined data on a storage medium, the apparatus comprising an authenticating unit which authenticates a host, which transmits a write command to the apparatus, to verify whether the host is authentic; at least one job module which generates output information by processing the user data, which is included in the write command, based on disc information stored in the storage medium and device information stored in the apparatus, in response to the write command; a module selecting unit which selects the job module based on module selection information and sends the write command to the selected job module, when the host is determined to be authentic, the module selection information being contained in the write command and specifying the job module; and a recording unit which records the output information on the storage medium.

According to another exemplary embodiment of the present invention, there is provided an apparatus for reproducing predetermined data from a storage medium, the apparatus including an authenticating unit which authenticates a host, which transmits a read command to the apparatus, to verify that the host is authentic; a reading unit which reads user data, which is indicated in the read command, from the storage medium, when the host is determined to be authentic; and at least one job module which generates output information by processing the read user data based on disc information stored in the storage medium and device information stored in the apparatus, and transmitting the output information to the host; and a module selecting unit which selects the job module based on module selection information and sends the read command to the selected job module, the module selection information being contained in the read command and specifying the job module.

According to yet another exemplary embodiment of the present invention, there is provided a method of recording predetermined data on a storage medium, the method including authenticating a host, which transmits a write command to a recording apparatus, to verify whether the host is authentic; selecting a job module based on module selection information when the host is determined to be authentic, the module selection information being contained in the write command and specifying the selected job module; generating output information by processing user data using the selected job module in response to the write command, based on disc information stored in the storage medium and device information stored in the recording apparatus, the user data included in the write command; and recording the output information on the storage medium.

According to still another exemplary embodiment of the present invention, there is provided a method of reproducing predetermined data from a storage medium, the method including authenticating a host, which transmits a read command to a reproducing apparatus, to verify whether the host is authentic; selecting a job module based on module selection information when the host is determined to be authentic, the module selection information being contained in the read command and specifying the job module; reading the user data, which is indicated in the read command, from the storage medium; and generating output information by processing the user data using the selected job module, based on disc information stored in the storage medium and device information stored in the reproducing apparatus.

### BRIEF DESCRIPTION OF THE DRAWINGS

The above and other exemplary embodiments and advantages of the present invention will become more apparent by describing in detail exemplary embodiments thereof with reference to the attached drawings in which:

FIG. 1 illustrates an optical disc system including a conventional content protection system;

FIG. 2 illustrates an internal structure of a recording/reproducing apparatus according to an exemplary embodiment of the present invention;

FIG. 3 is a flowchart illustrating a method of authenticating a host using an authenticating unit according to an exemplary embodiment of the present invention;

FIG. 4 illustrates mutual authentication between a host and a recording/reproducing apparatus, according to an exemplary embodiment of the present invention;

FIG. 5 is a diagram illustrating operations of a job module;

FIG. 6 is a diagram illustrating an operation of application software that records user data on a storage medium using a job module, according to an exemplary embodiment of the present invention;

FIG. 7 is a diagram illustrating an operation of application software that reads user data from a storage medium using a job module, according to an exemplary embodiment of the present invention; and

FIG. 8 is a flowchart illustrating a method of recording/reproducing data.

### DETAILED DESCRIPTION OF THE INVENTION

Hereinafter, exemplary embodiments of the present invention will be described in detail with reference to the accompanying drawings. The same reference numerals represent the same elements throughout the drawings.

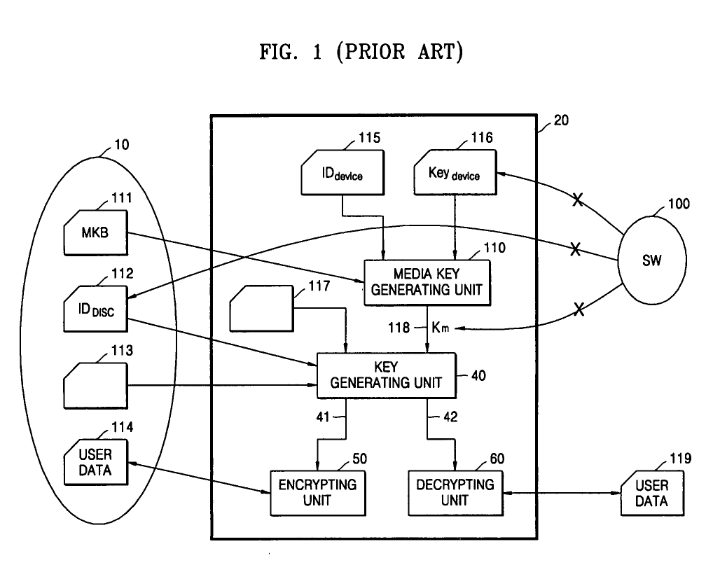

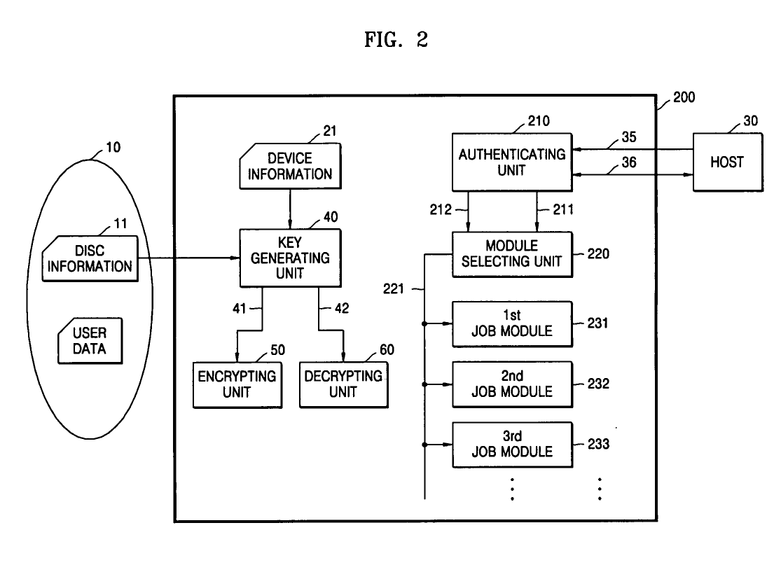

Referring to FIG. 2, a recording/reproducing apparatus 200 according to an exemplary embodiment of the present invention includes a key generating unit 40, an encrypting unit 50, a decrypting unit 60, an authenticating unit 210, a module selecting unit 220, and job modules 231, 232, 233, . . . . Disc information 11 includes information such as a media key block and a disc identifier that correspond to the media key block 111 and the disc identifier 112 of FIG. 1, respectively. Device information 21 includes information such as a device identifier and a device key set which correspond to the device identifier 115 and the device key set 116 of FIG. 1, respectively.

The authenticating unit 210 authenticates a host 30 to determine whether the host 30 is authentic and informs the host 30 that it is authentic. The host 30 may be any type of apparatus that allows application software loaded into the host 30 to send a write/read command 35, which instructs data to be written to or read from a storage medium 10, to the recording/reproducing apparatus 200.

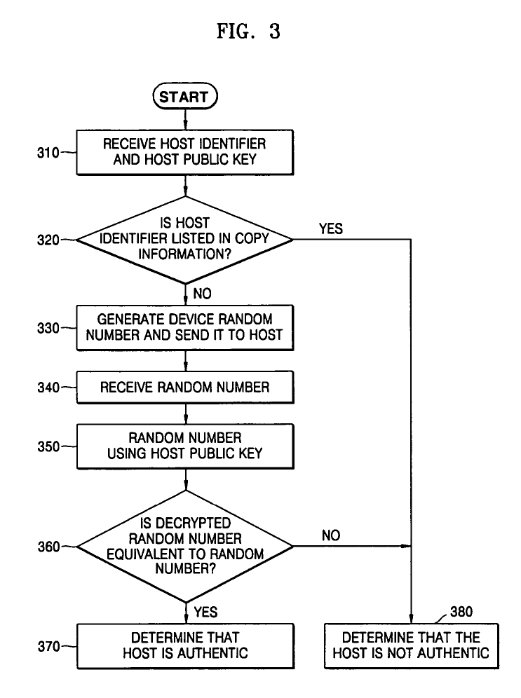

FIG. 3 is a flowchart illustrating an operation of the authenticating unit 210 of FIG. 2 that authenticates the host 30 of FIG. 2. When the authenticating unit 210 receives the write/read command 35 from the host 30, the authenticating unit 210 begins authentication. More specifically, the authenticating unit 210 receives a host identifier ID_host and a host public key Key_pub_host from the host 30 (operation 310). Before receipt of such information, generation of the host public key Key_pub_host by the host 30 that transmits the host identifier ID_host must be authenticated by an authentication authority.

Next, the authenticating unit 210 determines whether the received host identifier ID_host is listed in a revoked host identifier list included in predetermined revocation information (operation 320).

If it is determined in operation 320 that the received host identifier ID_host is listed in the revocation information, the authenticating unit 210 considers the connected host 30 as being an unauthentic host, rejects authentication of the host 30, and does not receive the write/read command 35 from the host 30 (operation 380). However, if it is determined in operation 320 that the received host identifier ID_host is not listed in the revocation information, the authenticating unit 210 performs additional authentication of operations 330 through 360. In operations 310 and 320, only whether the host identifier ID_host is included in the revocation information is checked, and in operations 330 through 360, whether the host identifier ID_host is related to the presently connected host 30 is determined.

More specifically, when the host identifier ID_host is not listed in the revocation information, the authenticating unit 210 generates a device random number RN_dev and sends it to the host 30 (operation 330). Then, the host 30 encrypts received random number RN_dev using its private key Key_pri_host to obtain encrypted random number E(Key_pri_host, RN_dev) and sends it to the recording/reproducing apparatus 20.

Next, the authenticating unit 210 receives the encrypted random number E(Key_pri_host, RN_dev) (operation 340) and decrypts it using the host public key Key_pub_host received in operation 310 to obtain a decrypted random number D{E(Key_pri_host, RN_dev)} (operation 350).

The authenticating unit 210 then compares the decrypted random number D{E(Key_pri_host, RN_dev)} obtained in operation 350 with the random number RN-dev obtained in operation 330 (operation 360). The encrypted random number E(Key_pri_host, RN_dev) encrypted using the host private key Key_pri_host is decrypted using the host public key Key_pub_host, and that the host public key Key_pub_host is related to the host 30 is authenticated by the authentication authority in operation 310. Therefore, the authenticating unit 210 can determine whether the connected host 30 has the host identifier ID_host.

If it is determined in operation 360 that the decrypted random number D{E(Key_pri_host, RN_dev)} is equivalent to the random number RN-dev, it is regarded that the authenticating unit 210 determines that the host 30 is authentic, and the recording/reproducing apparatus 200 receives the write/read command 35 from the host 30 (operation 370). Otherwise, the authenticating unit 210 determines that the host 30 is not authentic (operation 380).

Similarly, the host 30 can determine whether the recording/reproducing apparatus 200 is an authentic apparatus and permit or reject authentication of the recording/reproducing apparatus 200 based on the result of determination, thereby preventing application software from being accessed by an unauthorized apparatus such as an illegally revoked apparatus. In this case, the authenticating unit 210 receives a device identifier from the recording/reproducing apparatus 200 and determines whether it can be authenticated, using operations 310 through 380.

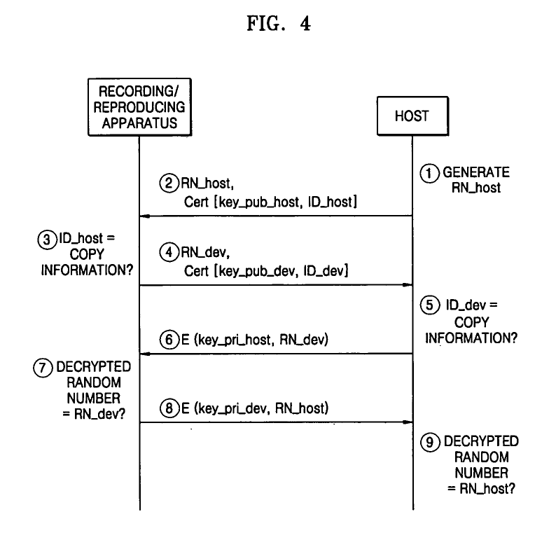

FIG. 4 illustrates mutual authentication between the host 30 and the recording/reproducing apparatus 200, according to an exemplary embodiment of the present invention. In the mutual authentication of FIG. 4, authentication for both the host 30 and the recording/reproducing apparatus 200 are simultaneously made.

Referring to FIG. 4, the authenticating unit 210 authenticates the host 30 via operations \mathring{2}, \mathring{3}, \mathring{4}, \mathring{6}, and \mathring{7}. In detail, the host 30 transmits a host public key Key_pub_host and a host identifier ID_host to the authenticating unit 210 (operation \mathring{2}), the authenticating unit 210 compares the host identifier ID_host with revocation information (operation \mathring{3}), the authenticating unit 210 generates a device random number RN_dev and transmits it to the host 30 (operation \mathring{4}), the host 30 sends encrypted random number E(Key_pri_host, RN_dev) to the recording/reproducing apparatus 200 (operation \mathring{6}) and the authenticating unit 210 decrypts the random number RN_dev and compares it with the decrypted random number D{E(Key_pri_host, RN_dev)} (operation \mathring{7}).

Also, the authenticating unit 210 authenticates the recording/reproducing unit 200 via operations \mathring{1}, \mathring{2}, \mathring{4}, \mathring{5}, \mathring{8}, and \mathring{9}. In detail, the authenticating unit 210 generates a host random number RN_host (operation \mathring{1}), the authenticating unit 210 transmits the host random number RN_host to the recording/reproducing apparatus 200 (operation \mathring{2}), the recording/reproducing unit 200 sends a device public key Key_pub_dev and a device identifier ID_dev to the authenticating unit 210 (operation \mathring{4}), the authenticating unit 210 compares the device identifier ID_dev with revocation information (operation \mathring{5}), the recording/reproducing apparatus 200 encrypts the random number RN_host to obtain an encrypted random number E(Key_pri_dev, RN_host) and sends it to the authenticating unit 210 (operation \mathring{8}), and the authenticating unit 210 decrypts the encrypted random number E(Key_pri_dev, RN_host) and compares it with the host random number RN_host (operation \mathring{9}).

Returning to FIG. 2, after the mutual authentication between the host 30 and the recording/reproducing apparatus 200, the authenticating unit 210 sends user data 211 and module selection information 212 to a module selecting unit 220 in response to the write/read command 35 input from the host 30. The user data 211, which is included in the write/read command 35, is recorded on or reproduced from a storage medium by the write/read command 35, and the module selection information 212 includes a module number designated by application software that instructs the host 30 to send the write/read command 35.

The module selecting unit 211 selects one of the job modules 231, 232, 233, . . . based on the module selection information 212 and sends the user data 211 using one selected from the job module 231, 232, 233, . . . . It is assumed that the job module 231 is selected by the module selecting unit 211.

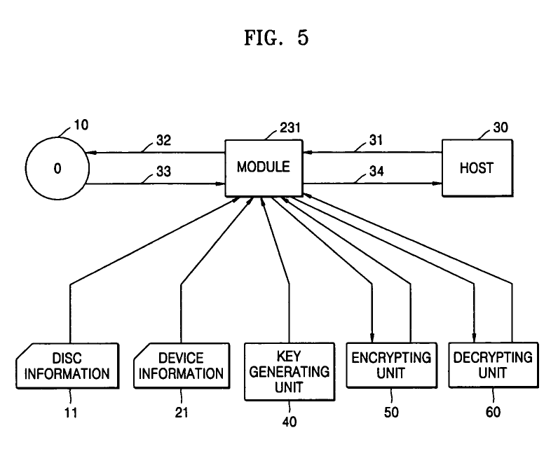

FIG. 5 is a diagram illustrating operations of the job module 231. Referring to FIG. 5, the job module 231 processes user data using the disc information 11 and the device information 21 and outputs the result of processing as output information. The output information is physically recorded on the storage medium 10 using a recording unit (not shown) or read from the storage medium 10 using a reading unit (not shown).

In a write mode, user data 31, which included in a write command input from the host 30, is transmitted to the job module 231. Although not shown in the drawings, the authenticating unit 210 and the module selecting unit 220 are installed along a path along which user data 31 is transmitted. The job module 231 generates output information 32 by processing the user data 33 based on the disc information 11 of FIG. 2 and the device information 21 of FIG. 2. The output information 34 may be recorded on a storage medium by a recording unit or read from the storage medium by a reproducing unit. The user data 32 may be processed using the key generating unit 40, the encrypting unit 50, and the decrypting unit 60. That is, the job module 231 sends the disc information 11, the device information 21, and the user data 33 to the key generating unit 40 in response to the write command, receives an output value from the key generating unit 40, and processes the user data 33 based on the output value.

In a read operation, the user data 33 is read from the storage medium 10 in response to a read command input from the host 30. The read user data 33 is input to the job module 231, and the job module 231 generates the output information 34 by processing the user data 33 based on the disc information 11 and the device information 21. Similarly, in the write operation, the user data 34 may be processed using the key generating unit 40, the encrypting unit 50, and the decrypting unit 60.

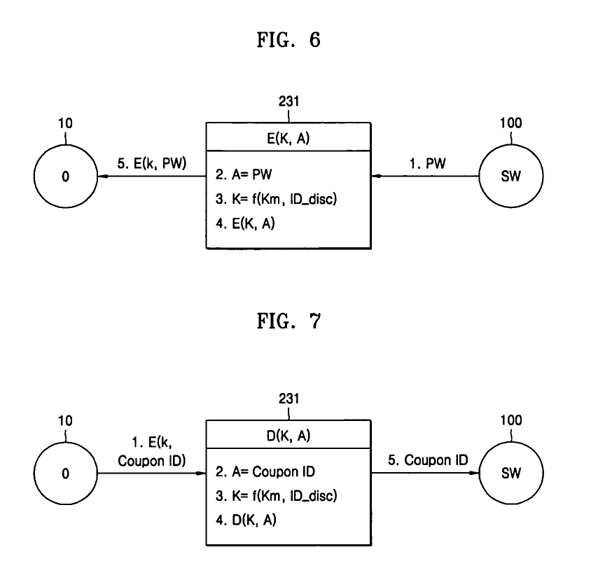

FIG. 6 illustrates an operation of the application software 100 that records user data on the storage medium 10 using the job module 231, according to an exemplary embodiment of the present invention. Authentication using the authenticating unit 210 and selection of the job module 231 using the module selecting unit 220 are as described above, and thus, their descriptions are omitted here.

The application software 100 encrypts a user password PW, which is an example of user data, and stores the result of encrypting in the storage medium 10. The job module 231 receives the user password PW as user data from the application software 100 and sets its function value A as PW. Next, the job module 231 generates an encrypting key K based on a media key Km contained in the device information 21 and a disc identifier ID_disc contained in the disc information 11, using the key generating unit 40. The job module 231 then encrypts the user password PW using the encrypting key K and generates output information. The encrypted password PW is stored in the storage medium 10 using a recording unit (not shown).

FIG. 7 is a diagram illustrating an operation of application software 100 that reads user data from the storage medium 10 using the job module 231, according to an exemplary embodiment of the present invention. Authentication using the authenticating unit 210 and selection of the job module 231 using the module selecting unit 220 are as described above, and thus, their descriptions are omitted here.

The application software 100 reads a coupon identifier Coupon_ID, which is another example of user data, from the storage medium 10. The coupon identifier Coupon_ID is encrypted and stored in the storage medium 10. A reading unit (not shown) reads the encrypted coupon identifier E(K,Coupon ID) from the storage medium 10 and transmits it to the job module 231. Next, the job module 231 sets its function value A as Coupon ID. The job module 231 then generates a decrypting key K based on the media key Km and the disc identifier ID_disc, using the key generating unit 40. Also, the job module 231 generates output information by decrypting the encrypted coupon identifier E(K,Coupon ID) using the decrypting key K. The decrypted coupon identifier Coupon ID is sent to the application software 100 via the host 30.

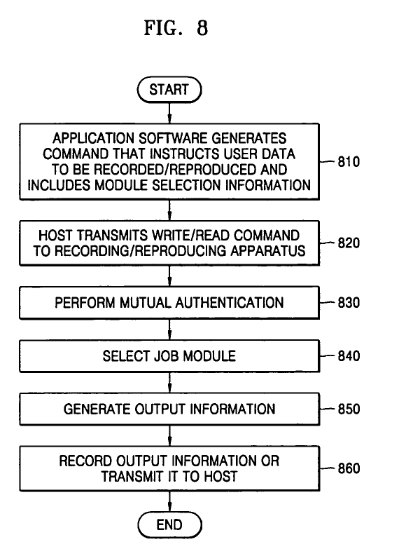

FIG. 8 is a flowchart illustrating a method of recording/reproducing data according to an exemplary embodiment of the present invention. Referring to FIG. 8, the application software 100 generates a write/read command that instructs user data to be recorded on or reproduced from the storage medium 10 (operation 810). The write/read command contains module selection information specifying the job module 231 that is to be selected.

Next, the write/read command is transmitted to the recording/reproducing apparatus 200 via the host 30 (operation 820).

Next, the authenticating unit 210 included in the recording/reproducing apparatus 200 performs mutual authentication between the host 30 and the recording/reproducing apparatus 200 (operation 830). Through the mutual authentication, whether the host 30 and the recording/reproducing apparatus 200 are authentic.

Next, the module selecting unit 220 selects the job module 231 based on the module selection information and transmits the user data in response to the write/read command (operation 840).

Next, the job module 231 receives the user data, processes it, and generates output information (operation 850). When the read command is input to the job module 231, the user data is read from the storage medium 10 and transmitted to the job module 231. When the write command is input to the job module 231, the user data is transmitted to the job module 231. Here, the user data is processed using device information stored in the recording/reproducing apparatus 200 and disc information stored in the storage medium 10.

The output information is recorded on the storage medium 10 or transmitted to the host 30 (operation 860).

As described above, a recording/reproducing method and apparatus the present invention allow application software to process data based on disc information and device information while providing security of the recording/reproducing apparatus.

While this invention has been particularly shown and described with reference to exemplary embodiments thereof, it will be understood by those skilled in the art that various changes in form and details may be made therein without departing from the spirit and scope of the invention as defined by the appended claims.

1. An apparatus for recording predetermined data on a storage medium, the apparatus comprising:
an authenticating unit which authenticates a host, which transmits a write command to the apparatus, to verify whether the host is authentic;
at least one job module which generates output information by processing user data, which is included in the write command, based on disc information stored in the storage medium and device information stored in the apparatus, in response to the write command;
a module selecting unit which selects the job module based on module selection information and sends the write command to the job module, if the host is determined to be authentic, the module selection information being contained in the write command and specifying the job module; and
a recording unit which records the output information on the storage medium.

2. The apparatus of claim 1, wherein the disc information comprises a disc identifier that enables identification of the storage medium and a media key block that prevents the apparatus from being illegally revoked.

3. The apparatus of claim 1, wherein the device information comprises a device identifier that enables identification of the apparatus, a device key set that is provided to the apparatus for preventing the apparatus from being illegally revoked, and a media key generated and stored in the apparatus based on the media key block and the device key set.

4. The apparatus of claim 1, further comprising:
an encrypting key generating unit which generates an encrypting key using the disc information stored in the storage medium and the device information stored in the apparatus; and
an encrypting unit which encrypts data input from the host, using the encrypting key,
wherein the job module generates the output information using the encrypting key generating unit and an output value generated by the encrypting unit.

5. The apparatus of claim 4, wherein the job module encrypts data input from the host using the encrypting unit.

6. The apparatus of claim 1, wherein the authenticating unit authenticates the host by comparing a host identifier transmitted from the host for identification of the host with predetermined revocation information that lists revoked host identifiers.

7. The apparatus of claim 6, wherein the authenticating unit receives from the host the host identifier together with a host public key, and generation of the host identifier and the host public key by the host is authenticated by an authentication authority.

8. The apparatus of claim 7, wherein the authenticating unit authenticates the host by generating and transmitting to the host a device random number receiving from the host an encrypted random number which is encrypted by the host using a private key corresponding to the host public key, decrypting the encrypted random number using the host public key, and determining whether a decrypted random number is equivalent to the device random number.

9. An apparatus for reproducing predetermined data from a storage medium, the apparatus comprising:
an authenticating unit which authenticates a host, which transmits a read command to the apparatus, to verify that the host is authentic;
a reading unit which reads user data, which is indicated in the read command, from the storage medium, if the host is determined to be authentic; and
at least one job module which generates output information by processing the user data read from the storage medium based on disc information stored in the storage medium and device information stored in the apparatus, and transmitting the output information to the host; and
a module selecting unit which selects the job module based on module selection information and sends the read command to the job module, the module selection information being contained in the read command and specifying the job module.

10. The apparatus of claim 9, wherein the disc information comprises a disc identifier that enables identification of the storage medium and a media key block that prevents the apparatus from being illegally revoked.

11. The apparatus of claim 9, wherein the device information comprises a device identifier that enables identification of the apparatus, a device key set that prevents the apparatus from being illegally revoked, and a media key generated based on the media key block and the device key set.

12. The apparatus of claim 9, further comprising:
an encrypting key generating unit which generates an encrypting key using the disc information stored in the storage medium and the device information stored in the apparatus; and
an encrypting unit which encrypts data input from the host using the encrypting key,
wherein the job module generates the output information using the encrypting key generating unit and an output value generated by the encrypting unit and.

13. The apparatus of claim 12, wherein the job module encrypts the user data using the encrypting unit.

14. The apparatus of claim 9, wherein the authenticating unit authenticates the host by comparing a host identifier transmitted from the host for identification of the host with predetermined revocation information that lists revoked host identifiers.

15. The apparatus of claim 14, wherein the authenticating unit receives from the host the host identifier together with a host public key, and generation of the host identifier and the host public key by the host is authenticated by an authentication authority.

16. The apparatus of claim 15, wherein the authenticating unit authenticates the host by generating and transmitting to the host a device random number receiving from the host an encrypted random number which is encrypted by the host using a private key corresponding to the host public key, decrypting the encrypted random number using the host public key, and determining whether a decrypted random number is equivalent to the device random number.

17. A method of recording predetermined data on a storage medium, the method comprising:
authenticating a host, which transmits a write command to a recording apparatus, to verify whether the host is authentic;
selecting a job module based on module selection information if the host is determined to be authentic, the module selection information being contained in the write command and specifying the job module;
generating output information by processing user data using the job module in response to the write command, based on disc information stored in the storage medium and device information stored in the recording apparatus, the user data being included in the write command; and
recording the output information on the storage medium.

18. The method of claim 17, wherein the disc information comprises a disc identifier that enables identification of the storage medium and a media key block that prevents the recording apparatus from being illegally revoked.

19. The method of claim 17, wherein the device information comprises a device identifier that enables identification of the recording apparatus, a device key set that prevents the recording apparatus from being illegally revoked, and a media key generated and stored in the recording apparatus based the media key block and the device key set.

20. The method of claim 17, wherein generating the output information comprises:
generating an encrypting key using the disc information stored in the storage medium and the device information stored in the recording apparatus; and
encrypting data input from the host using the encrypting key.

21. The method of claim 17, wherein authenticating the host comprises comparing predetermined revocation information that lists revoked host identifiers with a host identifier that is transmitted from the host for identification of the host.

22. The method of claim 21, wherein the host identifier is transmitted together with a host public key, and generation of the host identifier and the host public key by the host is authenticated by an authentication authority.

23. The method of claim 21, wherein authenticating the host comprises:
transmitting a device random number generated by the recording apparatus and a device identifier that enables identification of the recording apparatus to the host;
decrypting the device random number, which is encrypted by the host using a private key corresponding to the host public key, using the host public key; and
determining whether the encrypted device random number is equivalent to the device random number.

24. A method of reproducing predetermined data from a storage medium, the method comprising:
authenticating a host, which transmits a read command to a reproducing apparatus, to verify whether the host is authentic;
selecting a job module based on module selection information when the host is determined to be authentic, the module selection information being contained in the read command and specifying the job module;
reading the user data, which is indicated in the read command, from the storage medium; and
generating output information by processing the user data using the selected job module, based on disc information stored in the storage medium and device information stored in the reproducing apparatus.

25. The method of claim 24, wherein the disc information contains a disc identifier enabling identification of the storage medium and a media key block preventing the reproducing apparatus from being illegally revoked.

26. The method of claim 24, wherein the device information comprises a device identifier that enables identification of the reproducing apparatus, a device key set that prevents the reproducing apparatus from being illegally revoked, and a media key generated and stored in the reproducing apparatus based on the media key block and the device key set.

27. The method of claim 24, wherein generating the output information comprises:
generating a decrypting key based on the disc information stored in the storage medium and the device information stored in the reproducing apparatus; and
decrypting the user data using the encrypting key.

28. The method of claim 24, wherein authenticating the host comprises comparing predetermined revocation information that lists revoked host identifiers with a host identifier that is transmitted from the host for identification of the host.

29. The method of claim 27, wherein the host identifier is transmitted together with a host public key, and generation of the host identifier and the host public key by the host is authenticated by an authentication authority.

30. The method of claim 29, wherein authenticating the host comprises:
transmitting a device random number generated by the reproducing apparatus and a device identifier that enables identification of the reproducing apparatus to the host;
decrypting the device random number, which is encrypted by the host using a private key corresponding to the host public key, using the host public key; and
determining whether the decrypted random number is equivalent to the device random number.
